(19) United States
(12) Patent Application Publication
(10) Pub. No.: US 2012/0154694 A1
(43) Pub. Date: Jun. 21, 2012

(54) VIDEO PROJECTOR

(75) Inventors: Yosuke Nishihata, Hirakata-shi (JP); Akira Miyanaga, Daito-shi (JP); Shinya Noda, Neyagawa-shi (JP); Kei Yasukawa, Daito-shi (JP)

(73) Assignee: Sanyo Electric Co., Ltd., Osaka (JP)

(21) Appl. No.: 13/324,273

(22) Filed: Dec. 13, 2011

(30) Foreign Application Priority Data
Dec. 16, 2010 (JP) 2010-281031

(51) Int. Cl. H04N 9/31

(52) U.S. Cl. 348/744; 348/E09.025

(57) ABSTRACT

A projector is provided with a housing including an air inlet and an air filter that covers the air inlet. The air filter is arranged on the housing. A clogging detection sensor detects a clogging degree of the air filter. A projection lens, which serves as a presentation unit displays the clogging degree of the air filter. A control unit displays the clogging degree with the projection lens in three or more stages based on the detection result of the clogging degree.

### CROSS-REFERENCE TO RELATED APPLICATIONS

This application is based upon and claims the benefit of priority from prior Japanese Patent Application No. 2010-281031, filed on Dec. 16, 2010, the entire contents of which are incorporated herein by reference.

### BACKGROUND OF THE INVENTION

The present invention relates to a video projector including a housing, which is provided with an air inlet, an air filter, which covers the air inlet, and a clogging detection sensor, which detects the clogging degree of the air filter.

A video projector includes a housing that accommodates optical components and electronic components, which are generally cooled by air drawn into the housing through an air inlet. Such a video projector includes an air filter that covers the air intake so that dust, which is suspended in air, does not enter the housing through the air inlet.

Japanese Laid-Open Patent Publication No. 2008-2652035 describes a video projector that automatically recovers a dust capturing capacity of the air filter when the clogging degree of the air filter becomes large.

Japanese Laid-Open Patent Publication No. 2007-47843 describes a video projector that issues a notification indicating that the air filter is clogged when the clogging degree of the air filter becomes large. This video projector includes a means for detecting clogging of the filter. The detecting means generates a warning when detecting clogging of the filter.

When the dust capturing capacity of the air filter cannot be recovered, like in the video projector of Japanese Laid-Open Patent Publication No. 2007-47843, a notification should be issued to prompt a user to replace the air filter when the clogging degree of the air filter becomes large. However, the video projector of Japanese Laid-Open Patent Publication No. 2007-47843 issues such a notification only after the logging degree of the air filter becomes large and does not prompt the user to exchange the air filter before the clogging degree becomes large.

### SUMMARY OF THE INVENTION

One aspect of the present invention is a video projector provided with a housing including an air inlet. An air filter covers the air inlet. The air filter is arranged on the housing. A clogging detection sensor detects a clogging degree of the air filter. A presentation unit displays the clogging degree. A control unit displays the clogging degree with the presentation unit in three or more stages based on the detection result of the clogging degree.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram of a video projector according to a first embodiment of the present invention;

FIGS. 2(a) to 2(d) are diagrams showing examples of clogging degree messages displayed by the video projector of the first embodiment;

FIG. 3 is a graph showing changes in the dust capture degree of an air filter;

FIG. 4 is a graph showing changes in a correction coefficient for correcting the dust capture degree of an air filter in a video projector according to a second embodiment of the present invention;

FIG. 5 is a graph showing changes in the dust capture degree of the air filter when the usage time of the air filter has not exceeded an normal usage time in the video projector of the second embodiment;

FIG. 6 is a graph showing changes in the dust capture degree of the air filter when the usage time of the air filter has exceeded an exchange recommendation time in the video projector of the second embodiment;

FIG. 7 is a graph showing changes in the dust capture degree of the air filter when the usage time of the air filter has not exceeded the normal usage time in the video projector according to a third embodiment of the present invention;

FIG. 8 is a graph showing changes in the dust capture degree of the air filter when the usage time of the air filter has exceeded the normal usage time and the exchange recommendation time in the video projector of the third embodiment; and

FIG. 9 is a graph showing changes in the dust capture degree of the air filter when the usage time of the air filter has exceeded the exchange recommendation time in the video projector of the third embodiment.

### DESCRIPTION OF THE INVENTION

### First Embodiment

A first embodiment of the present invention will now be described with reference to the drawings.

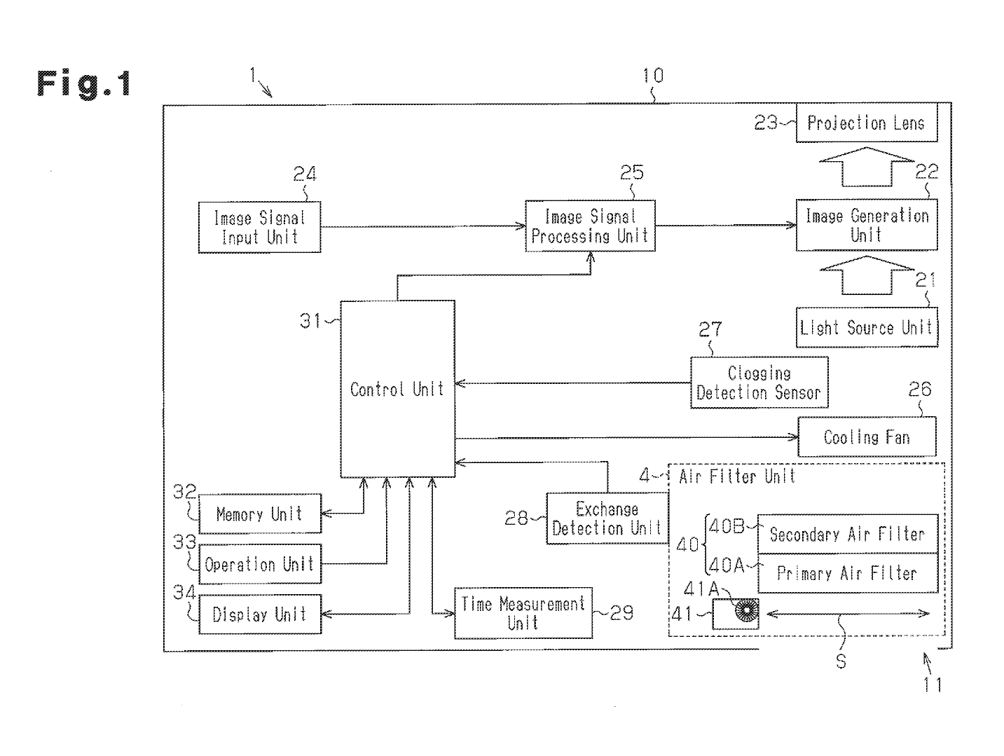

As shown in FIG. 1, a projector 1, which is a video projector, includes a housing 10, which accommodates electronic components, optical components, and the like. The housing 10 includes an air inlet 11. Ambient air is drawn into the housing 10 through the air inlet 11.

The projector 1 includes a light source unit 21, an image generation unit 22, and a projection lens 23. The light source unit 21 generates light for displaying an image and functions as an optical component for displaying an image. The image generation unit 22 generates an image with the light generated by the light source unit 21. The projection lens 23 projects light of the generated image and functions as a projection unit.

The light source unit 21 is formed by a discharge lamp, such as an ultrahigh pressure mercury lamp or a metal halide lamp. The light generated by the light source unit 21 enters the image generation unit 22.

The image generation unit 22 is formed by an electro-optical device including, for example, liquid crystal panels, which are dot matrix type light valves, or a digital micromirror device, which is formed by micromirrors arranged in a grid-shaped array. An input signal is input to the image generation unit 22 to drive the liquid crystal panels or DMD. Light from the light source 21 enters the image generation unit 22 and is passed through the liquid crystal panels or reflected by the DMD to generate an image based on the image signal.

The projection lens 23 serves as a presentation unit that displays an image by projecting light. The projection lens 23 is formed by a lens group that project light of an image generated by the image generation unit 22. Accordingly, the light of an image is projected outward from the projector 1 through the projection lens 23 and displayed on a flat surface, such as a screen or a wall.

The projector 1 also includes an image signal input unit 24 and an image signal processing unit 25. The image signal input unit 24 receives an image signal, which is an electrical signal, from outside the projector 1 and functions to generate an image based on the image signal. The image signal processing unit 25 processes the image signal.

The image signal input unit 24 includes an image signal input terminal, which is connected to, for example, an image cable (not shown). The projector 1 receives an image signal from an external device, such as a personal computer (PC) or an image reproduction device, through the image signal input unit 24. The image signal input unit 24 may be a wireless module that receives an image signal through wireless communication.

The image signal processing unit 25 includes a signal processing circuit that performs various types of signal processing, such as on-screen display (OSD) processing, on an image signal input to the projector 1. The OSD processing combines an image based on an image signal with another image. The projector 1 includes a control unit 31 to control signal processing in the projector 1. An image signal, which has undergone signal processing in the image signal processing unit 25, is input to the image generation unit 22.

Further, the projector 1 includes a cooling fan 26, an air filter 40, and a clogging detection sensor 27. The cooling fan 26 produces an air current directed toward the optical components of the light source unit 21 and image generation unit 22. The air filter 40 captures dust, which is suspended in air. The clogging detection sensor 27 detects the clogging degree of the air filter 40.

The cooling fan 26 functions as a blower that draws ambient air into the housing 10 through the air inlet 11 and directs the drawn in air toward the discharge lamp and liquid crystal panels, which are heated to a high temperature.

The air filter 40, which covers the air inlet 11, includes a primary air filter 40A and a secondary air filter 40B, which are stacked together. The secondary air filter 40B is an electrostatic air filter and captures dust that is not captured by the primary air filter 40A.

In the present embodiment, the housing 10 includes an air filter unit 4, which is coupled to the housing 10 in a removable manner. Removal of the air filter unit 4 from the housing 10 allows for the secondary air filter 40B to be exchanged when the dust capturing capacity cannot be recovered. Further, the air filter unit 4 includes a filter cleaner 41 that cleans the primary air filter 40A. The filter cleaner 41, which includes a rotary brush 41A, moves in the directions indicated by arrow S while rotating the rotary brush 41A to clean the primary air filter 40A of the air filter 40. The filter cleaner 41 starts cleaning based on the usage time of the primary air filter 40A.

The clogging detection sensor 27 detects the flow rate of the air moved by the cooling fan 26, that is, the flow rate of air passing through the air filter 40. Based on the flow rate of air passing through the air filter 40, the clogging detection sensor 27 generates a signal indicating the clogging degree of the air filter 40 and sends the signal to the control unit 31. The clogging detection sensor 27 detects the flow rate of the air passing through the air filter 40 immediately after the air filter 40 is cleaned. The result of the clogging degree detection by the clogging detection sensor 27 is input to the control unit 31 and stored in a memory unit 32.

The projector 1 also includes an exchange detection unit 28, which detects exchange of the air filter 40, and a time measurement unit 29, which measures the usage time of the air filter 40. In addition to the control unit 31, which controls each part of the projector 1, and the memory unit 32, which stores the information required to control each part of the projector 1, the projector 1 includes an operation unit 33, which is operated by a user or the like of the projector 1, and a display unit 34, which shows an image to the user or the like of the projector 1.

The exchange detection unit 28 includes a sensor that detects exchange of the air filter 40 through the removal and coupling of the air filter unit 4. When the air filter 40 is replaced, the exchange detection unit 28 sends a signal to the control unit 31 indicating that the air filter 40 has been replaced.

The time measurement unit 29 is a timer counter that measures the usage time of the air filter 40. More specifically, the time measurement unit 29 measures the usage time of the primary air filter 40A and the secondary air filter 40B. The usage time of each of the primary air filter 40A and the secondary air filter 40B is, for example, the accumulated time during which the cooling fan 26 is activated. When the replacement of the air filter 40 is detected, the usage time is reset to “0”.

The control unit 31 is formed by an integrated circuit that controls the image signal processing unit 25, cooling fan 26, light source unit 21, display unit 34, and the like. The control unit 31, which is a computer, calculates a dust capture degree of the air filter 40 based on the clogging degree detection result of the air filter 40.

The memory unit 32 includes a non-volatile memory that stores information such as programs executed by the control unit 31. The memory unit 32 stores information such as numerals used for computations by the control unit 31.

The operation unit 33 includes, for example, push buttons. The operation unit 33 is a user interface operated by the user or the like of the projector. The control unit 31 controls the image signal processing unit 25 in accordance with the operation of the operation unit 33.

The display unit 34 includes, for example, an LCD panel and functions as a user interface that displays information for the user or the like of the projector 1. The display unit 34 is controlled by the control unit 31 to display various types of information.

The operation of the projector 1 when displaying the clogging degree will now be described.

When the operation unit 33 is operated to display the clogging degree of the air filter 40, the control unit 31 controls the image signal processing unit 25 to perform OSD processing for displaying the clogging degree of the air filter 40 based on the detection result of the clogging degree.

The image signal processing unit 25 performs the OSD processing to display the clogging degree of the air filter 40. An image signal that has undergone OSD processing, that is, an image signal indicating the clogging degree of the air filter 40, is input to the image generation unit 22.

The projection lens 23 projects an image indicating the clogging degree of the air filter 40 and displays the image on a flat surface such as a screen. In this manner, the projection lens 23 displays the clogging degree of the air filter 40 as an image. The control unit 31 controls the image signal processing unit 25 to change the image displayed by the projection lens 23.

The clogging degree of the air filter 40, which is displayed as an image, changes in accordance with the clogging degree detection result of the clogging detection sensor 27. That is, the control unit changes the image of indicating the displayed clogging degree of the air filter based on the clogging degree detection result of the clogging detection sensor 27. Images for three or more stages of the clogging degree of the air filter 40 are displayed.

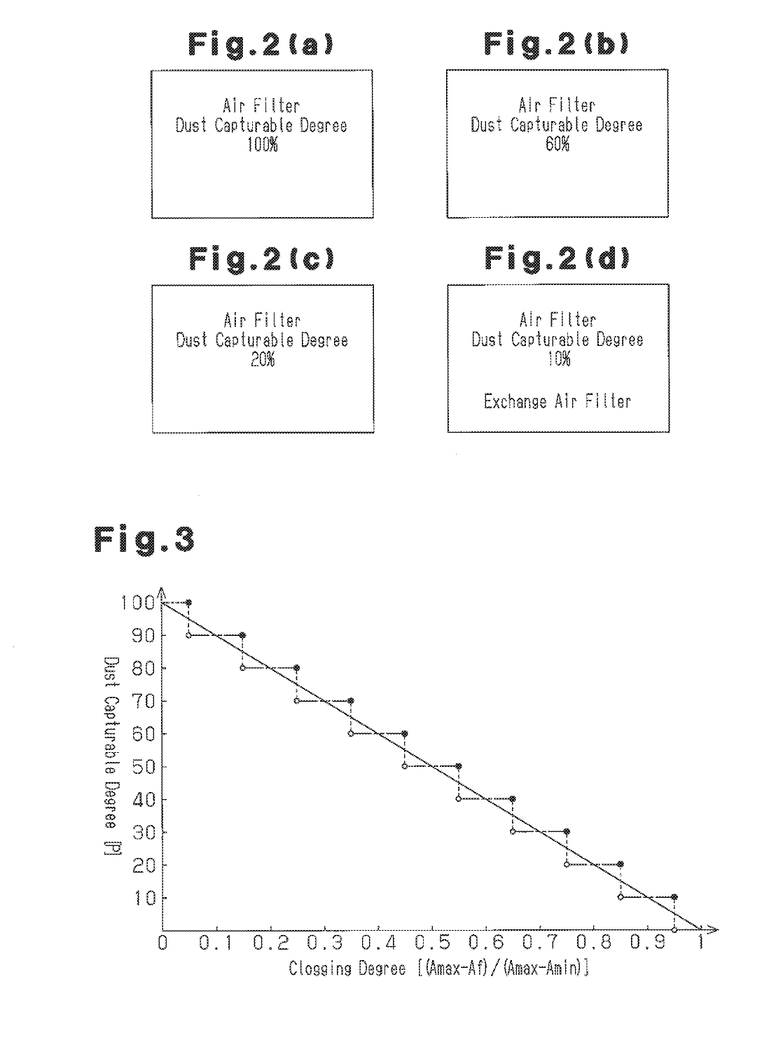

FIGS. 2(a) to 2(d) show examples of images indicating the clogging degree of the air filter 40. In the image examples of FIGS. 2(a) to 2(d), the clogging degree of the air filter 40 is shown as the dust capture degree of the air filter 40. As the clogging degree of the air filter 40 increases, the dust capture degree of the air filter 40 decreases.

In the present embodiment, the dust capture degree of the air filter 40 is indicated by a numeral that is 0 or greater and 100 or less. The control unit 31 increments and decrements the numeral by 10. More specifically, the dust capture degree of the air filter 40 is indicated in the eleven stages of “0”, “10”, “20”, “30”, “40”, “50”, “60”, “70”, “80”, “90”, and “100”. Referring to FIG. 2(d), when the dust capture degree of the air filter 40 is small, that is, when the clogging degree of the air filter 40 is large, the control unit 31 controls the image signal processing unit 25 to display the dust capture degree of the air filter 40 together with a message prompting the user to replace the air filter 40.

The numerals indicating the dust capture degree of the air filter 40 will now be described. Equation (1), which is shown below, is used to calculate the dust capture degree of the air filter 40. Then, the first digit of the calculated value is rounded off to obtain the dust capture degree.

$$P = 100 \times \{ 1 - \frac{Amax - Af}{Amax - Amin} \} \qquad ( 1 )$$

In equation (1), “P” represents the dust capture degree, “Af” represents the flow rate of air detected by the clogging detection sensor 27, “Amax” represents the flow rate of the air that passes through the air filter 40 when the air filter 40 is not clogged, and “Amin” represents the flow rate of the air passing through the air filter when the clogging degree of the air filter 40 is maximal. The flow rate Af that satisfies the expression of “Amin≦Af≦Amax” decreases as the clogging degree of the air filter 40 increases. When the clogging degree of the air filter 40 is maximal, the flow rate of the air passing through the air filter 40 decreases. In this state, the flow rate of the air passing through the air filter 40 is low, and a sufficient amount of air cannot be ensured to cool the interior of the housing 10.

FIG. 3 is a graph showing a solid line representing equation (1). The graph shows the relationship of the dust capture degree of the air filter 40 and the clogging degree of the air filter 40. The vertical axis in the graph of FIG. 3 corresponds to the dust capture degree of the air filter 40, which is represented by “P” in equation (1). The horizontal axis in the graph of FIG. 3 corresponds to the clogging degree of the air filter 40, which is represented by “(Amax−Af)/(Amax−Amin)” in equation (1).

In FIG. 3, the broken line represents the dust capture degree of the air filter 40 when the first digit of “P” is rounded off. As shown by the broken line in FIG. 3, the dust capture degree of the air filter 40, which is indicated by numerals incremented or decremented by 10 in the range of 0 or greater and 100 or less, decreases in steps from 100 to 0 as the clogging degree increases. When the clogging degree is 0 or greater and 0.05 or less, “P” is 95 or greater and 100 or less, and the dust capture degree of the air filter 40 is “100”. When the clogging degree is greater than 0.05 and 0.15 or less, “P” is 85 or greater and less than 95, and the dust capture degree of the air filter 40 is “90”. In this manner, when the clogging degree increases, the displayed dust capture degree is decremented by 10. When the clogging degree is greater than 0.95 and less than 1, “P” is greater than 0 and less than 5, and the dust capture degree of the air filter 40 is “0”. When the clogging degree is 1, the control unit 31 deactivates the light source unit 21.

The present embodiment has the advantages described below.

(1) The projector 1 includes a projection lens 23, which serves as the presentation unit that displays the clogging degree of the air filter 40, and the control unit 31, which changes the image indicating the clogging degree of the air filter 40 based on the clogging degree detection result of the air filter 40. Images for three or more stages of the clogging degree of the air filter 40 are displayed. This notifies the user of the clogging degree of the air filter 40 and prompts the user or the like to replace the air filter 40 before the clogging degree of the air filter 40 increases. As a result, the air filter 40 is replaced before the clogging degree becomes great. This prevents the temperature in the housing 10 from rising.

(2) The clogging degree of the air filter 40 is indicated by numerals of 0 or greater and 100 or less, and the control unit 31 increments and decrements the numeral that is displayed as the clogging degree of the air filter. In this manner, the clogging degree of the air filter 40 is expressed in percentage. Thus, the user can easily recognize the clogging degree of the air filter 40.

(3) The clogging detection sensor 27 is a flow rate sensor that detects the flow rate of the air passing through the air filter 40. Thus, the clogging detection sensor 27, which is a flow rate sensor, can determine whether or not the flow rate can cool the optical components, such as the light source unit 21, and electronic components in the housing 10.

(4) The clogging detection sensor 27 detects the flow rate of the air that passes through the air filter 40 based on changes in the temperature inside the housing 10. Thus, the clogging detection sensor 27 can be used to determine whether or not the temperature has reached an abnormal level that adversely affects the optical components, such as the light source unit 21, and electronic components in the housing 10.

(5) The projector 1 includes the filter cleaner 41 that cleans the air filter 40. The filter cleaner 41 can recover the dust capturing capacity by cleaning the air filter 40 with the filter cleaner 41 and decreasing the clogging degree of the air filter 40.

(6) The clogging detection sensor 27 detects the flow rate of the air that passes through the air filter as a physical amount indicating the clogging degree of the air filter 40 immediately after the filter cleaner 41 cleans the primary air filter 40A. The cleaning of the primary air filter 40A lowers the clogging degree of the primary air filter 40A. Thus, the clogging degree of the air filter 40 is based on the physical amount of the clogging degree immediately after the primary air filter 40A is cleaned. This accurately detects the clogging degree of the secondary air filter 40E.

(7) The projection lens 23, which projects the clogging degree of the air filter 40 as an image, forms the presentation unit that displays the clogging degree of the air filter 40. That is, the projection lens 23 projects an image of the clogging degree of the air filter 40 to display the clogging degree of the air filter 40. Thus, the clogging degree of the air filter 40 may be projected onto and displayed on a flat surface such as a screen.

### Second Embodiment

A second embodiment of the present invention will now be described. To avoid redundancy, components that are the same as the corresponding components of the first embodiment will not be described below in detail.

In the second embodiment, the control unit 31 calculates the dust capture degree of the air filter 40 based on the clogging degree detection result of the air filter 40 and the usage time of the air filter 40.

Equation (2) is used in the second embodiment to calculate the dust capture degree P. Equation (1) is multiplied by a correction coefficient, which is represented by “a” in equation (2).

$$P = 100 \times \{ 1 - \frac{( Amax - Af )}{( Amax - Amin )} \} \times α \qquad ( 2 )$$

The correction coefficient α is a number that is in accordance with the usage time of the air filter 40. More specifically, the correction coefficient α differs between when the usage time of the air filter 40 has not exceeded an normal usage time, when the usage time has exceeded the normal usage time but not an replacement recommendation time, and when the usage time has exceeded the replacement recommendation time. The normal usage time is a first predetermined time, and the replace recommendation time is a second predetermined time that is longer than the first predetermined time.

Equation (3) is used to calculate the correction coefficient α when the usage time of the air filter 40 has not exceeded the normal usage time (e.g., 1000 hours). In equation (3), “β” represents a predetermined positive coefficient, “T” represents the usage time of the air filter 40, and “Ta” represents the normal usage time. The coefficient β is, for example, 0.2.

$$α = 1 + \{ β \times \frac{( Ta - T )}{Ta} \} \qquad ( 3 )$$

The correction coefficient α is greater than 1 when the usage time has not exceeded the normal usage time. As the usage time of the air filter 40 increases, the correction coefficient α approaches 1.

When the usage time of the air filter 40 exceeds the normal usage time but not the replacement recommendation time (e.g., 5000 hours), the correction coefficient α is 1. When the correction coefficient α is 1, equation (2) is equivalent to equation (1). Further, the correction coefficient α is 1 when the usage time of the air filter 40 is within the normal usage time and when the usage time of the air filter 40 is within the replacement recommendation time.

When the usage time of the air filter 40 exceeds the replacement recommendation time, equation (4) is used to calculate the correction coefficient α. In equation (4), “Tb” represents the replacement recommendation time and “Tc” represents a limit usage time, where Tb is smaller than Tc. The limit usage time is, for example, 6000 hours.

$$α = \frac{( Tc - T )}{( Tc - Tb )} \qquad ( 4 )$$

When the usage time of the air filter 40 exceeds the replacement recommendation time, the correction coefficient α is smaller than 1. As the usage time of the air filter 40 increases, the correction coefficient α approaches 0. When the usage time of the air filter 40 is the same as the limit usage time, the correction coefficient α is 0.

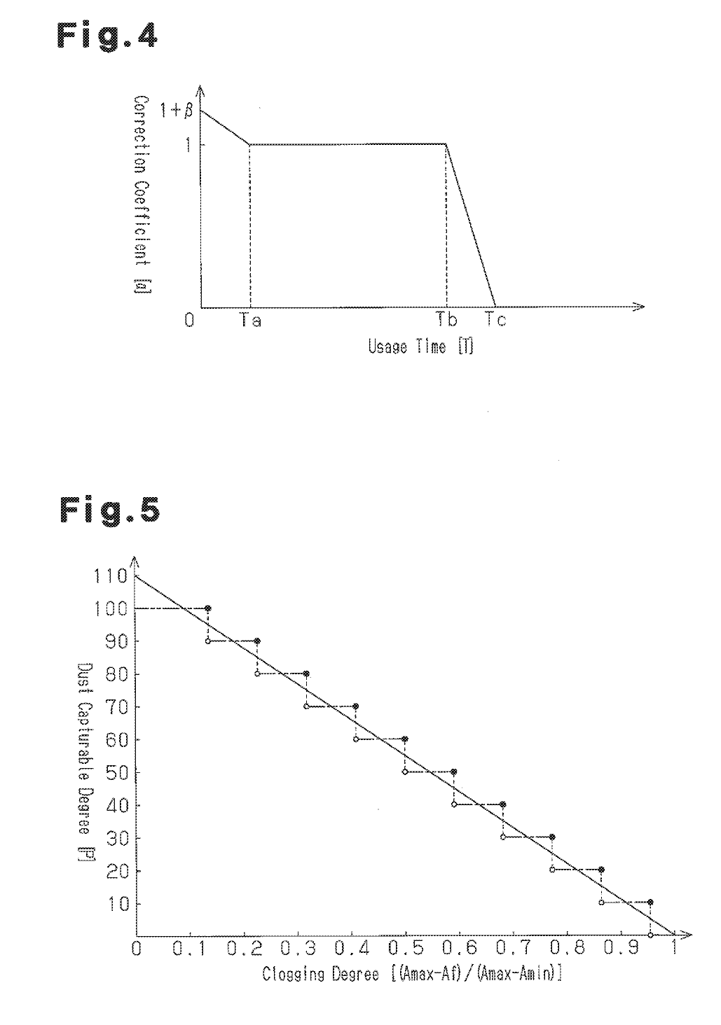

Accordingly, as shown in FIG. 4, when the usage time of the air filter 40 has not exceeded the normal usage time and the replacement recommendation time, the correction coefficient α is a value other than 1. When the correction coefficient α is the value other than 1, the dust capture degree P is corrected by the correction coefficient in accordance with the usage time of the air filter 40. In this manner, in the present embodiment, the air filter dust capturing degree is indicated based on the clogging degree detection result of the clogging detection sensor 27 and the usage time of the air filter 40 measured by the time measurement unit 29.

FIG. 5 is a graph showing a solid line representing equation (2) when the coefficient β is 0.2 and the usage time T of the air filter 40 is 500 hours. The graph shows the relationship of the dust capture degree of the air filter 40 and the clogging degree of the air filter 40. Here, the correction coefficient α is 1.1.

In the same manner as the broken line in FIG. 3, the broken line in FIG. 5 represents the dust capture degree of the air filter 40, which is indicated by numerals incremented or decremented by 10 in the range of 0 or greater and 100 or less. When P exceeds 100, the dust capture degree of the air filter 40 is “100”. When the usage time of the air filter 40 is 500 hours and the clogging degree is 0 or greater and 0.13 or less, “P” is 95 or greater and 110 or less, and the dust capture degree of the air filter 40 is “100”. Accordingly, when the clogging degree is greater than 0.05 and 0.13 or less, the dust capture degree of the air filter 40 when the usage time of the air filter 40 has not exceeded the normal usage time is displayed as a greater degree than when the usage time has exceeded the normal usage time. In this manner, when the correction coefficient α is greater than 1, the dust capture degree of the air filter 40 is easily maintained at “100”.

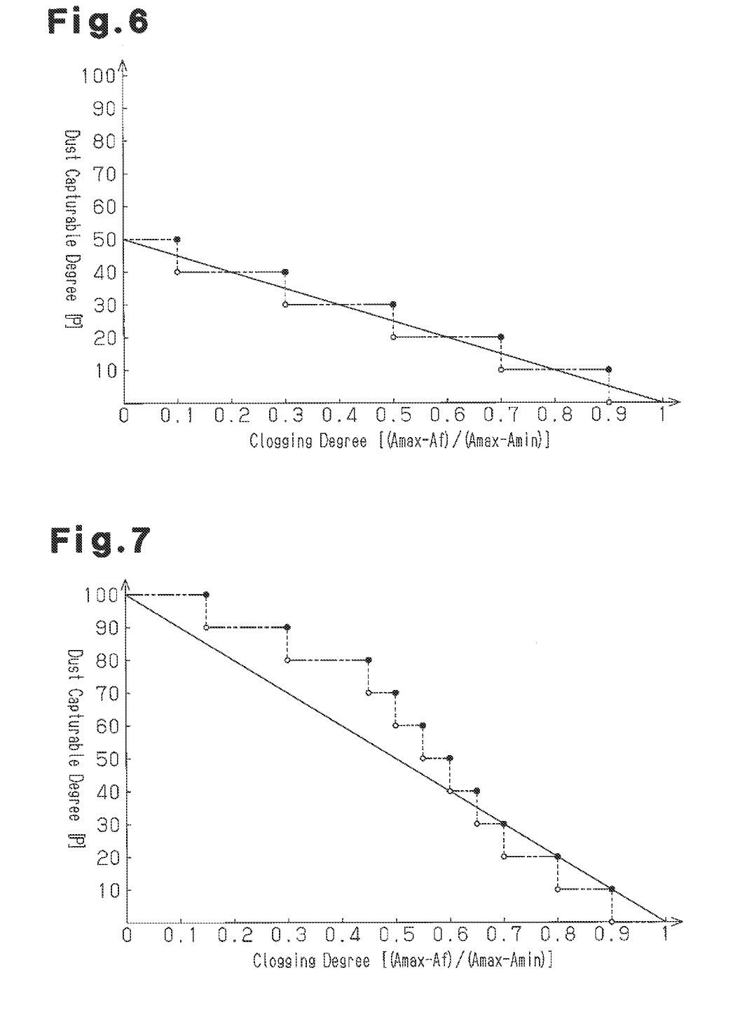

FIG. 6 is a graph showing a solid line representing equation (2) when the replacement recommendation time Tb is 5000 hours, the limit usage time Tc is 6000 hours, and the usage time T of the air filter 40 is 5500 hours. The graph shows the relationship of the dust capture degree of the air filter 40 and the clogging degree of the air filter 40. Here, the correction coefficient α is 0.5.

In the same manner as the broken lines in FIGS. 3 and 5, the broken line in FIG. 6 represents the dust capture degree of the air filter 40, which is indicated by numerals incremented or decremented by 10 in the range of 0 or greater and 100 or less. When the usage time of the air filter 40 is 5500 hours and the clogging degree is 0 or greater and 0.10 or less, “P” is 45 or greater and 50 or less, and the dust capture degree of the air filter 40 is “50”. When the usage time of the air filter 40 is 5500 hours and the clogging degree is greater than 0.9 and 1 or less, “P” is greater than 0 and less than 5, and the dust capture degree of the air filter 40 is “0”. Accordingly, when the clogging degree is small, taking wear of the secondary air filter 40B into account, the dust capture degree of the air filter 40 when the usage time of the air filter 40 has exceeded the replacement recommendation time is displayed as a smaller degree than when the usage time has not exceeded the replacement recommendation time.

In addition to advantages (1) to (7), the second embodiment has the advantages described below.

(8) The projector 1 includes the time measurement unit 29, which measures the usage time of the air filter 40, and displays the dust capture degree of the air filter 40 based on the clogging degree detection result of the air filter 40 and the usage time of the air filter 40. Thus, the user is notified of the degree of wear of the air filter 40 in addition to the clogging degree of the air filter 40.

(9) In comparison to when the usage time of the air filter 40 exceeds the normal usage time, the dust capture degree of the air filter 40 is greater when the usage time of the air filter 40 has not exceeded the normal usage time. Accordingly, when the air filter 40 is replaced and the measurement of the usage time of the air filter 40 starts, the dust capturing degree is displayed as a greater degree when the elapsed time from the replacement of the air filter 40 has not exceeded the normal usage time than when the elapsed time from the replacement of the air filter 40 has exceeded the normal usage time. Thus, when the elapsed time from the replacement of the air filter 40 has not exceeded the normal usage time, the user is notified that the necessity for exchanging the air filter 40 is low.

(10) The dust capture time of the air filter 40 is smaller when the usage time of the air filter 40 has exceeded the replacement recommendation time than when the usage time has not exceeded the replacement recommendation time. Accordingly, when the air filter 40 is replaced and the measurement of the usage time of the air filter 40 starts, the dust capturing degree is displayed as a smaller degree when the elapsed time from the replacement of the air filter 40 has exceeded the replacement recommendation time than when the elapsed time from the replacement of the air filter 40 has not exceeded the replacement recommendation time. Thus, when the elapsed time from the replacement of the air filter 40 has exceeded the replacement recommendation time, the user is notified that the necessity for exchanging the air filter 40 is high.

### Third Embodiment

A third embodiment of the present invention will now be described. To avoid redundancy, components that are the same as the corresponding components of the first embodiment will not be described below in detail.

In the same manner as in the second embodiment, in the third embodiment, the control unit 31 obtains the dust capture degree of the air filter 40 based on the clogging degree detection result of the air filter 40 and the usage time of the air filter 40.

In the third embodiment, a table is used to obtain the dust capture degree of the air filter 40, which is a numeral displayed as an image. In the third embodiment, a plurality of tables is used to obtain the dust capture degree in accordance with the usage time of the air filter 40. The data for the tables used to obtain the dust capture degree is stored in the memory unit 32.

When the usage time of the air filter 40 has not reached the normal usage time (e.g., 1000 hours), the control unit 31 controls the displayed degree based on table (1), which is shown below.

TABLE 1

| DUST CAPTURE DEGREE P | DISPLAYED DEGREE |
|---|---|
| 85 OR GREATER AND 100 OR LESS | 100 |
| 70 OR GREATER AND LESS THAN 85 | 90 |
| 55 OR GREATER AND LESS THAN 70 | 80 |
| 50 OR GREATER AND LESS THAN 55 | 70 |
| 45 OR GREATER AND LESS THAN 50 | 60 |
| 40 OR GREATER AND LESS THAN 45 | 50 |
| 35 OR GREATER AND LESS THAN 40 | 40 |
| 30 OR GREATER AND LESS THAN 35 | 30 |
| 20 OR GREATER AND LESS THAN 30 | 20 |
| 10 OR GREATER AND LESS THAN 20 | 10 |
| GREATER THAN 0 AND LESS THAN 0 | 0 |

Equation (1), which is shown above, is used to calculate the dust capture degree P.

FIG. 7 is a graph showing the relationship, when the usage time of the air filter 40 has not exceeded the normal usage time, of the dust capture degree of the air filter 40 and the clogging degree of the air filter 40. In FIG. 7, the solid line represents equation (1). Like the other drawings, the broken line in FIG. 7 represents the dust capture degree of the air filter 40, which is indicated by numerals incremented or decremented by 10 in the range of 0 or greater and 100 or less. The broken line represents degrees obtained from table (1). In the third embodiment, when the usage time of the air filter 40 has not exceeded the normal usage time, the dust capture degree of the air filter 40 is maintained at a large degree.

When the usage time of the air filter 40 has exceeded the normal usage time but not the replacement recommendation time (e.g., 5000 hours), the control unit 31 controls the displayed degree based on table (2), which is shown below.

TABLE 2

| DUST CAPTURE DEGREE P | DISPLAYED DEGREE |
|---|---|
| 100 | 100 |
| 90 OR GREATER AND LESS THAN 100 | 90 |
| 80 OR GREATER AND LESS THAN 90 | 80 |
| 70 OR GREATER AND LESS THAN 80 | 70 |
| 60 OR GREATER AND LESS THAN 70 | 60 |
| 50 OR GREATER AND LESS THAN 60 | 50 |
| 40 OR GREATER AND LESS THAN 50 | 40 |
| 30 OR GREATER AND LESS THAN 40 | 30 |
| 20 OR GREATER AND LESS THAN 30 | 20 |
| 10 OR GREATER AND LESS THAN 20 | 10 |
| GREATER THAN 0 AND LESS THAN 10 | 0 |

Equation (1), which is shown above, is used to calculate the dust capture degree P.

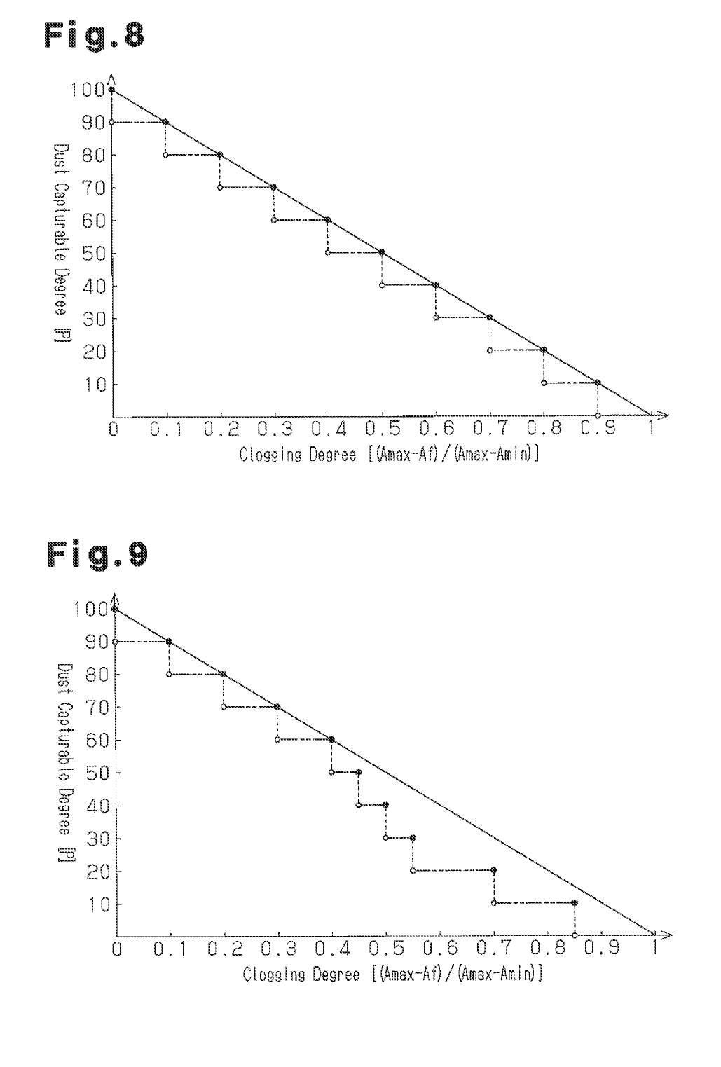

FIG. 8 is a graph showing the relationship, when the usage time of the air filter 40 has exceeded the normal usage time but not the replacement recommendation time, of the dust capture degree of the air filter 40 and the clogging degree of the air filter 40. In FIG. 8, the solid line represents equation (1). Like the other drawings, the broken line in FIG. 8 represents the dust capture degree of the air filter 40, which is indicated by numerals incremented or decremented by 10 in the range of 0 or greater and 100 or less. The broken line represents degrees obtained from table (2).

When the usage time of the air filter 40 has exceeded the replacement recommendation time, the control unit 31 controls the displayed degree based on table (3), which is shown below.

TABLE 3

| DUST CAPTURE DEGREE P | DISPLAYED DEGREE |
|---|---|
| 100 | 100 |
| 90 OR GREATER AND LESS THAN 100 | 90 |
| 80 OR GREATER AND LESS THAN 90 | 80 |
| 70 OR GREATER AND LESS THAN 80 | 70 |
| 60 OR GREATER AND LESS THAN 70 | 60 |
| 55 OR GREATER AND LESS THAN 60 | 50 |
| 50 OR GREATER AND LESS THAN 55 | 40 |
| 45 OR GREATER AND LESS THAN 50 | 30 |
| 30 OR GREATER AND LESS THAN 45 | 20 |
| 15 OR GREATER AND LESS THAN 30 | 10 |
| GREATER THAN 0 AND LESS THAN 15 | 0 |

Equation (1), which is shown above, is used to calculate the dust capture degree P.

FIG. 9 is a graph showing the relationship, when the usage time of the air filter 40 has exceeded the replacement recommendation time, of the dust capture degree of the air filter 40 and the clogging degree of the air filter 40. In FIG. 9, the solid line represents equation (1). Like the other drawings, the broken line in FIG. 9 represents the dust capture degree of the air filter 40, which is indicated by numerals incremented or decremented by 10 in the range of 0 or greater and 100 or less. The broken line represents degrees obtained from table (3).

In addition to advantages (1) to (10), the third embodiment has the advantages described below.

(11) The control unit 31 obtains dust capture degree of the air filter 40 from the tables stored in the memory unit 32. Thus, in comparison with the second embodiment, the computation load is reduced, and the dust capture degree of the air filter 40 is easily and flexibly determined.

It should be apparent to those skilled in the art that the present invention may be embodied in many other specific forms without departing from the spirit or scope of the invention. Particularly, it should be understood that the present invention may be embodied in the following forms.

The display unit 34 of the housing 10 may display the clogging degree of the air filter 40. That is, the presentation unit that displays the clogging degree of the air filter 40 may be the display unit 34, which is arranged on the housing 10. This displays the clogging degree of the air filter 40 without having to project an image of the clogging degree of the air filter 40.

In the second embodiment, the correction coefficient α may be a constant value. In such a case, the correction coefficient α only needs to be greater than 1 when the usage time of the air filter 40 has not exceeded the normal usage time. Further, the correction coefficient α only needs to be less than 1 when the usage time of the air filter 40 has not exceeded the replacement recommendation time.

The second embodiment may be modified so that “P” is not corrected when the usage time of the air filter 40 has not exceeded the normal usage time.

The second embodiment may be modified so that “P” is not corrected when the usage time of the air filter 40 has not exceeded the replacement recommendation time.

In the third embodiment, a plurality of tables does not have to be used to obtain the dust capture degree in accordance with the usage time of the air filter 40. For example, regardless of the usage time of the air filter 40, the control unit 31 may determine the displayed degree based on table (2). This obtains the same advantages as the first embodiment.

The clogging detection sensor 27 may be formed by a sensor other than a flow rate sensor. For example, the clogging detection sensor 27 may be a temperature sensor or a pressure sensor. When a temperature sensor, which detects the temperature in the housing 10, is used as the clogging detection sensor 27, the temperature sensor can be used to determine whether or not the temperature in the housing 10 has reached an abnormal level that adversely affects the optical components, such as the light source unit 21, and electronic components in the housing 10.

The dust capture degree of the air filter 40 may be displayed in forms other than numerals.

The present examples and embodiments are to be considered as illustrative and not restrictive, and the invention is not to be limited to the details given herein, but may be modified within the scope and equivalence of the appended claims.

1. A video projector comprising:
a housing including an air inlet;
an air filter that covers the air inlet, wherein the air filter is arranged on the housing;
a clogging detection sensor that detects a clogging degree of the air filter;
a presentation unit for displaying the clogging degree; and
a control unit that displays the clogging degree with the presentation unit in three or more stages based on the detection result of the clogging degree.

2. The video projector according to claim 1, wherein
the clogging degree is displayed as a numeral that is 0 or greater and 100 or less, and
the control unit increments or decrements the numeral of the clogging degree from 0 or greater to 100 or less in three or more stages.

3. The video projector according to claim 1, wherein the clogging detection sensor includes a flow rate sensor that detects a flow rate of air passing through the air filter.

4. The video projector according to claim 1, wherein the clogging detection sensor includes a temperature sensor that detects a temperature in the housing.

5. The video projector according to claim 1, wherein the clogging detection sensor includes a pressure sensor that detects a pressure of air passing through the air filter.

6. The video projector according to claim 1, wherein the clogging detection sensor detects a flow rate of air that passes through the air filter based on a temperature change in the housing.

7. The video projector according to claim 1, further comprising a time measurement unit that measures a usage time of the air filter, wherein the control unit calculates a dust capture degree of the air filter based on the detection result of the clogging degree and the usage time of the air filter, and the control unit displays the dust capture degree with the presentation unit.

8. The video projector according to claim 7, wherein the control unit displays, with the presentation unit, a larger dust capture degree of the air filter when the usage time of the air filter has not exceeded a first predetermined time than when the usage time of the air filter has exceeded the first predetermined time.

9. The video projector according to claim 8, wherein the control unit displays, with the presentation unit, a smaller dust capturing degree of the air filter when the usage time of the air filter has exceeded a second predetermined time, which is longer than the first predetermined time, than when the usage time of the air filter has not exceeded the second predetermined time.

10. The video projector according to claim 9, wherein the first predetermined time is 1000 hours of usage time of the air filter, and the second predetermined time is 5000 hours of usage time of the air filter.

11. The video projector according to claim 7, wherein
the control unit uses the detection result of the clogging degree and a correction coefficient to calculate the dust capture degree of the air filter, and
the correction coefficient is set in accordance with the usage time of the air filter.

12. The video projector according to claim 11, wherein
the correction coefficient is set to be a value that is greater than 1 when the usage time of the air filter is within a first predetermined time,
the correction coefficient is set to the value of 1 when the usage time of the air filter has exceeded the first predetermined time but is within a second predetermined time, which is longer than the first predetermined time, and
the correction coefficient is set to a value that is less than 1 when the usage time of the air filter has exceeded the second predetermined time.

13. The video projector according to claim 12, wherein
the correction coefficient changes from a value greater than 1 toward 1 as the usage time of the air filter approaches the first predetermined time, and
the correction coefficient changes from 1 to 0 as the usage time of the air filter elapses from the second predetermined time.

14. The video projector according to claim 1, further comprising a filter cleaner that cleans the air filter.

15. The video projector according to claim 14, wherein
the air filter includes a primary air filter and a secondary air filter that are stacked together,
the clogging detection sensor detects a physical amount, which indicates the clogging degree, immediately after the filter cleaner cleans the primary air filter, and
the control unit displays the clogging degree with the presentation unit based on the physical amount detected immediately after the primary air filter is cleaned.

16. The video projector according to claim 1, wherein the presentation unit includes a projection unit that projects the clogging degree as an image.

17. The video projector according to claim 1, wherein the presentation unit is arranged on the housing.
